(19) United States
(12) Patent Application Publication
(10) Pub. No.: US 2005/0172329 A1
(43) Pub. Date: Aug. 4, 2005

(54) ONU device for switching channels

(76) Inventors: Kwan-Lae Kim, Suwon-si (KR); Sung-Jin Park, Suwon-si (KR); Young-Seok Kim, Seongnam-si (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(21) Appl. No.: 10/932,873

(22) Filed: Sep. 2, 2004

(30) Foreign Application Priority Data
Jan. 29, 2004 (KR) 2004-5773

(51) Int. Cl. H04N 7/173; H04N 5/445; G06F 13/00; H04N 5/50; H04N 5/45

(52) U.S. Cl. 725/129; 725/118; 348/731; 725/38

(57) ABSTRACT

An ONU device is disclosed. The ONU device is capable of channel switching in a broadcasting-telecommunications convergence system where digital broadcasting signals of channels are switched according to subscribers, converged with communication signals destined for the subscribers, and transmitted to the subscribers. In the ONU device, a channel information extractor extracts channel switching information about digital broadcasting contents included in the digital broadcasting signals, a channel switching information database stores the extracted channel switching information and provides the channel switching information according to channel selection information from a subscriber received from a zapping processor, and the zapping processor outputs a control signal for channel switching according to the channel switching information.

### CLAIM OF PRIORITY

This application claims priority under 35 U.S.C. § 119 to an application entitled “ONU Device Capable of Effectively Switching Channels,” filed in the Korean Intellectual Property Office on Jan. 29, 2004 and assigned Serial No. 2004-5773, the contents of which are incorporated herein by reference.

### BACKGROUND OF THE INVENTION

1. Field of the Invention

The present invention relates generally to a broadcasting-telecommunications convergence system, and in particular, to a device for switching a broadcast video signal for a broadcasting service.

2. Description of the Related Art

Broadcasting systems typically have a number of properties or characteristics. They are unidirectional. They distribute information to an indefinite number of users. There is also a coincidence between a service provider and a network provider. In contrast to broadcasting systems, telecommunication systems are bidirectional and have one-to-one transmission/reception. Telecommunication systems may also have different service providers and network providers.

FIG. 1 is a block diagram of a broadcasting-telecommunications convergence system. The broadcasting-telecommunications convergence system includes an optical line terminal (OLT) 11, an optical network unit (ONU) 200, and an optical cable connecting them. The OLT 11 is a sub-system between a service node and subscribers 13 for receiving a broadcasting signal from a broadcasting service provider and a communication signal from a telecommunications service provider. The communication signal is electro-optically converted and the resulting optical signal is output in order to simultaneously provide a broadcasting service including digital broadcasting and a communication service such as a high-speed Internet service. The ONU 12 is a subscriber device for delivering information received from the OLT 11 to the subscribers 13.

In the broadcasting-telecommunications convergence system of FIG. 1, the OLT 11 transmits a plurality of digital broadcasting channel signals in one optical signal. The ONU 12 demultiplexes the optical signal into the digital broadcasting channel signals and switches them to the subscribers 13 according to channel selection information received from them, together with corresponding communication signals.

FIG. 2 is a detailed block diagram of the ONU 12 in the broadcasting-telecommunications system. The ONU 12 includes an opto-electric (O/E) converter 201 for opto-electrically converting an optical signal received from the OLT 11, a demultiplexer (DEMUX) 202 for demultiplexing the electrical signal received from the O/E converter 201, and a broadcast video processor 203 for converting digital broadcasting signals for respective channels received from the DEMUX 202 to broadcast video signals for the channels. The ONU 12 also includes a broadcast video switch 204 for switching the broadcast video signals received from the broadcast video processor 203 according to subscribers, a subscriber transmitter 205 for transmitting a broadcast video signal received from the broadcast video switch 204 and communication data received from a communication data processor 206 to a corresponding subscriber 13 connected to the ONU 12 and transmitting channel selection information and communication data received from the subscriber 13 to the communication data processor 206. The communication data processor 206 transmits communication data received from the DEMUX 202 to the subscriber transmitter 205 and transmits the upstream communication data and channel selection information received from the subscriber transmitter 205 to the DEMUX 202. The ONU 12 further includes a zapping processor 207 for transmitting the channel selection information to the broadcast video switch 204 so that the broadcast video signals can be switched to corresponding subscribers 13.

Generally, a broadcast video signal is transmitted in MPEG-2 (Moving Picture Experts Group-2). The MPEG-2 standard deals with two multiplexed bit streams: program stream and transport stream.

The program stream is designed for use in multiplexing of a broadcasting program (video+audio+ancillary data) in an error-free channel environment or in the case where the error correction function of a medium itself like a compact disk (CD) is utilized. The transport stream is designed for multiplexing in the case where a plurality of broadcasting programs are simultaneously transmitted in an error channel environment. That is, when one program is stored like a video CD, the program stream is used, whereas the transport stream is used for digital broadcasting of a plurality of programs using satellites.

As described above, switching of a plurality of broadcast video signals requires the transport stream. Broadcast video signals illustrated in FIG. 2 are delivered in one transport stream.

The following is a more detailed description of a transport stream decoding system and a channel switching operation in the decoding system. As disclosed in ISO/IEC (International Standard Organization/International Electrotechnical Commission) 13818, a decoding system, which includes a basic stream decoder with at least one MPEG-2 audio decoder and at least one MPEG-2 video decoder, and an MPEG-2 transport decoder, receives an MPEG-2 transport stream (bit stream) from a plurality of service providers. The MPEG-2 transport stream may be from various source types and contain a plurality of programs to be displayed for users. Therefore, channel switching from one program to another program requires switching from one transport stream source to another transport stream source.

If data of an intended channel is contained in the current transport stream received in the decoding system, the latency between selection of the new channel and display of the data of the new channel is determined as time required for resynchronization to the data of the new channel depending on the performance of the transport decoder and the basic stream decoder.

On the other hand, if the intended channel is not in the current transport stream and thus data is to be selected from another transport stream, the latency is longer. In this case, the transport decoder must be switched to a new transport stream. Also, the transport decoder must check the PSI (Program Specific Information) tables to parse and decode programs from the new transport stream. Thus, the latency for channel switching may become very long. As a result, services such as a digital broadcasting service cannot be provided actively to users.

That is, the broadcast video switch 204 switches broadcast video signals to users based on channel selection information received from the zapping processor 207. When switching from a channel signal included in the broadcast video signals to a channel signal in another transport stream occurs, the latency for channel switching is increased.

### SUMMARY OF THE INVENTION

One aspect of the present invention relates to an ONU device for preliminarily storing broadcast video channel information about each transport stream such that broadcast video channels can be effectively switched without processing transport streams.

One embodiment of the present invention is directed to an ONU device capable of channel switching in a broadcasting-telecommunications convergence system where digital broadcasting signals of channels are switched according to subscribers, converged with communication signals destined for the subscribers, and transmitted to the subscribers. In the ONU device, a channel information extractor extracts channel switching information about digital broadcasting contents included in the digital broadcasting signals, a channel switching information database stores the extracted channel switching information and provides the channel switching information according to channel selection information from a subscriber received from a zapping processor, and the zapping processor outputs a control signal for channel switching according to the channel switching information.

Another embodiment of the present invention is directed to a method for channel switching in a broadcasting-telecommunications convergence system. The method includes the steps of extracting channel switching information about digital broadcasting contents included in a plurality of digital broadcasting signals, determining a switch control signal for channel switching in accordance with the extracted channel switching information and a channel selection signal from a subscriber and switching, in accordance with the switch control signal, at least one of the plurality of the digital broadcast signals to the subscriber.

Yet another embodiment of the present invention is directed to a device capable of channel switching digital signals. The device includes a channel information extractor for extracting channel switching information about digital contents included in the digital signals, a channel switching information database for storing the extracted channel switching information and providing the channel switching information according to channel selection information from a user; and a controller for transmitting the channel selection information received from the user to the channel switching information database, receiving the channel switching information from the channel switching information database, and outputting a control signal for channel switching.

### BRIEF DESCRIPTION OF THE DRAWINGS

The above and other aspects, features and embodiments of the present invention will become more apparent from the following detailed description when taken in conjunction with the accompanying drawings in which:

FIG. 1 is a block diagram of a broadcasting-telecommunications convergence system;

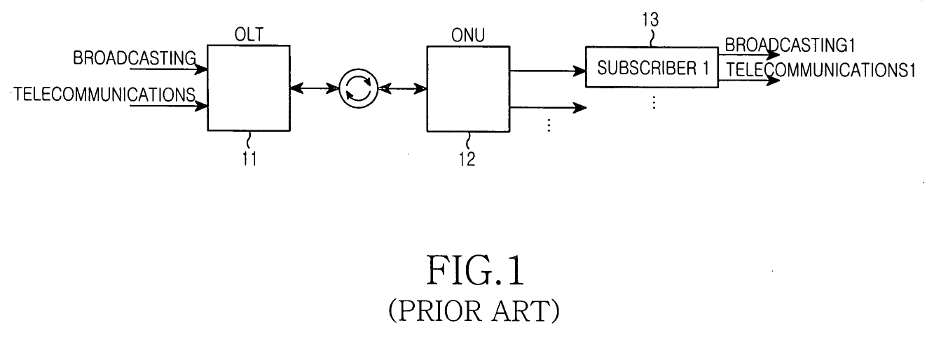

FIG. 2 is a detailed block diagram of an ONU in the broadcasting-telecommunications convergence system illustrated in FIG. 1; and

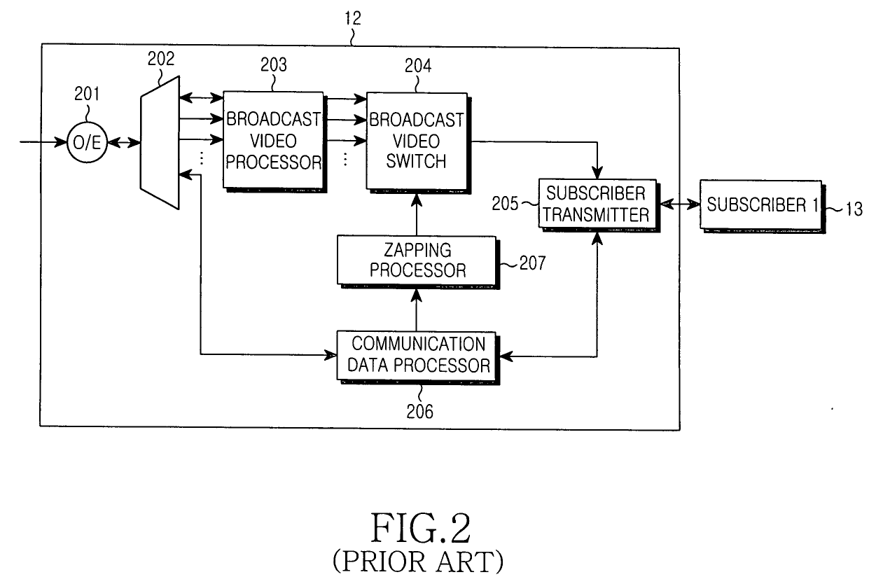

FIG. 3 is a block diagram of an ONU device capable of switching channels in the broadcasting-telecommunications convergence system according to one embodiment of the present invention.

### DETAILED DESCRIPTION

Embodiments of the present invention will be described herein below with reference to the accompanying drawings. For the purposes of clarity and simplicity, well-known functions or constructions are not described in detail as they would obscure the invention in unnecessary detail.

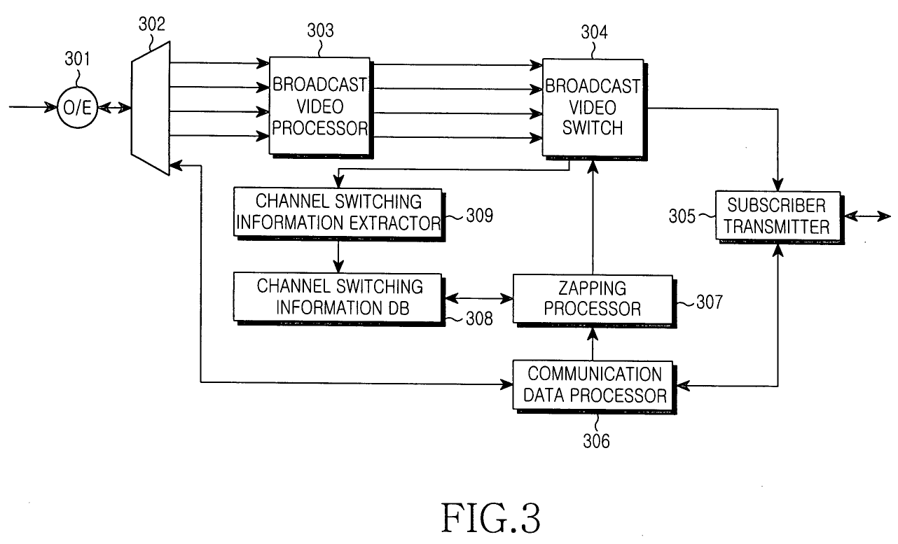

Referring to FIG. 3, the ONU device according to one embodiment of the present invention includes an O/E converter 301 for opto-electrically converting an optical signal received from an OLT, a DEMUX 302 for demultiplexing the electrical signal received from the O/E converter 301, and a broadcast video processor 303 for converting digital broadcasting signal for respective channels received from the DEMUX 302 to broadcast video signals for the channels. The ONU also includes a broadcast video switch 304 for switching the broadcast video signals received from the broadcast video processor 303 to corresponding subscribers, a subscriber transmitter 305 for transmitting a broadcast video signal received from the broadcast video switch 304 and communication data received from a communication data processor 306 to a corresponding subscriber connected to the ONU 12 and transmitting channel selection information and communication data received from the subscriber to the communication data processor 306. The communication data processor 306 transmits communication data received from the DEMUX 302 to the subscriber transmitter 305 and transmits the upstream communication data and channel selection information received from the subscriber transmitter 305 to the DEMUX 302.

The ONU further includes a zapping processor 307 for transmitting the channel selection information to a channel switching information database (DB) 308, receiving channel switching information from the channel switching information DB 308, and transmitting a control signal to the broadcast video switch 304 to allow switching of a broadcast video signal to each subscriber through the broadcast video switch 304. The ONU also includes a channel switching information extractor 309 for extracting information about channels being serviced by the broadcast video switch 304, and the channel switching information DB 308 for storing the channel switching information received from the channel switching information extractor 309, receiving the channel selection information from the zapping processor 307, and correspondingly providing the channel switching information of the broadcast video switch 304 to the zapping processor 307.

In operation, broadcast video signals in a transport stream input to the broadcast video switch 304 are separated into pure broadcast video contents and channel switching information. The channel switching information maybe extracted periodically or non-periodically by the channel switching information extractor 309. The non-periodic extraction refers to extraction during idle time.

The channel switching information indicates the positions of the broadcast video contents included in the broadcast video signals. By the channel switching information, a broadcast video signal containing particular broadcast video contents (e.g. SBS broadcasting) is identified.

The channel switching information about the broadcast video contexts input to the broadcast video switch 304 is stored in the channel switching information DB 308. An example of such a database is illustrated in Table 1 below.

TABLE 1

| Position of broadcast video | | |
|---|---|---|
| contents | | |
| (position of input signal to | | |
| broadcast video switch) | Channel information | Channel number |
| 1 | KBS1 | 9 |
| 1 | KBS2 | 7 |
| 3 | MBC | 11 |
| 4 | SBS | 6 |

Referring to Table 1, the channel switching information DB 308 has information about the positions of input signals to the broadcast video switch 304 (i.e. the numbers of input ports) and broadcasting channel information like KBS1 and KBS2. In this embodiment, the contents position information and the channel information form the channel switching information. The channel switching information DB 308 further includes channel numbers indicating the broadcasting channels to thereby facilitate transmission of the channel switching information according to channel selection information received from the zapping processor 307.

Upon receipt of the channel selection information generated from a user device such as a set top box through the zapping processor 307, the channel switching information DB 308 transmits the contents position information to the zapping processor 307.

The zapping processor 307 transmits control information including the content position information and the channel information to the broadcast video switch 304.

The broadcast video switch 304 identifies an input port that receives broadcast video contents corresponding to the contents position information, separates the broadcast video contents from a broadcast video signal received through the input port according to the channel information, and switches the broadcast video contents to the corresponding subscriber.

As described above, channel switching information maybe periodically extracted and stored in the channel switching information DB and only control information for physical switching is transmitted to the broadcast video switch. Thus, the broadcast video switch switches broadcast video contents to subscribers rapidly, as compared to a conventional technology in which channel switching information about broadcast video contents is processed according to channel selection information from subscribers.

Considering that the channel switching information input to the broadcast video switch is changeable at any time, it is extracted periodically or during idle time. Thus, the channel switching information stored in the channel switching information DB matches to broadcast video contents being serviced by the broadcast video switch.

While the invention has been shown and described with reference to a certain embodiments thereof, it is a mere exemplary application. For example, while the channel switching information DB and the channel switching structure are described in use in an ONU device in a broadcasting-telecommunications convergence system, they are also applicable to other systems such as an MPEG-2 switching device for switching a plurality of MPEG-2 transport streams according to channels. Therefore, it will be understood by those skilled in the art that various changes in form and details may be made therein without departing from the spirit and scope of the invention as defined by the appended claims.

1. An optical network unit (ONU) device capable of channel switching in a broadcasting-telecommunications convergence system where digital broadcasting signals of channels are switched according to subscribers, converged with communication signals destined for the subscribers, and transmitted to the subscribers, comprising:
a channel information extractor for extracting channel switching information about digital broadcasting contents included in the digital broadcasting signals;
a channel switching information database for storing the extracted channel switching information and providing the channel switching information according to channel selection information from a subscriber received from a zapping processor; and
the zapping processor for transmitting the channel selection information received from the subscriber to the channel switching information database, receiving the channel switching information from the channel switching information database, and outputting a control signal for channel switching.

2. The ONU device of claim 1, wherein the control signal contains the channel switching information and the channel selection information.

3. The ONU device of claim 1, wherein the channel information extractor extracts the channel switching information periodically.

4. The ONU device of claim 2, wherein the channel information extractor extracts the channel switching information periodically.

5. The ONU device of claim 1, wherein the channel information extractor extracts the channel switching information non-periodically during idle time.

6. The ONU device of claim 2, wherein the channel information extractor extracts the channel switching information non-periodically during idle time.

7. A method for channel switching in a broadcasting-telecommunications convergence system, comprising the steps of:
extracting channel switching information about digital broadcasting contents included in a plurality of digital broadcasting signals;
determining a switch control signal for channel switching in accordance with the extracted channel switching information and a channel selection signal from a subscriber; and
switching, in accordance with the switch control signal, at least one of the plurality of the digital broadcast signals to the subscriber.

8. The method of claim 7, wherein the switch control signal contains the channel switching information and the channel selection information.

9. The method of claim 1, wherein the extracting step extracts the channel switching information periodically.

10. The method of claim 8, wherein the extracting step extracts the channel switching information periodically.

11. The method of claim 7, wherein the extracting step extracts the channel switching information non-periodically during idle time.

12. The method of claim 8, wherein the extracting step extracts the channel switching information non-periodically during idle time.

13. The method of claim 7 further comprising the step of storing the extracted channel switching information

14. A device capable of channel switching digital signals, comprising:
a channel information extractor for extracting channel switching information about digital contents included in the digital signals;
a channel switching information database for storing the extracted channel switching information and providing the channel switching information according to channel selection information from a user; and
a controller for transmitting the channel selection information received from the user to the channel switching information database, receiving the channel switching information from the channel switching information database, and outputting a control signal for channel switching.

15. The device of claim 14, wherein the control signal contains the channel switching information and the channel selection information.

16. The device of claim 14, wherein the channel information extractor extracts the channel switching information periodically.

17. The device of claim 15, wherein the channel information extractor extracts the channel switching information periodically.

18. The device of claim 14, wherein the channel information extractor extracts the channel switching information non-periodically during idle time.

19. The device of claim 15, wherein the channel information extractor extracts the channel switching information non-periodically during idle time.
